(19) United States
(12) Patent Application Publication
(10) Pub. No.: US 2026/0066313 A1
(43) Pub. Date: Mar. 5, 2026

(54) SINGLE CELL FOR FUEL CELL

(71) Applicant: TOYOTA BOSHOKU KABUSHIKI KAISHA, Aichi-ken (JP)

(72) Inventors: Haruyuki AONO, Aichi-ken (JP); Kohei MINOSHIMA, Nagoya-shi (JP)

(73) Assignee: TOYOTA BOSHOKU KABUSHIKI KAISHA, Aichi-ken (JP)

(21) Appl. No.: 19/308,980

(22) Filed: Aug. 25, 2025

(30) Foreign Application Priority Data
Sep. 2, 2024 (JP) 2024-150454

(51) Int. Cl. H01M 8/0254; H01M 8/0273; H01M 8/0284

(52) U.S. Cl. CPC H01M 8/0254; H01M 8/0273; H01M 8/0284

(57) ABSTRACT

A single cell for a fuel cell includes a frame-shaped holding plate to which an edge of a membrane electrode gas diffusion layer assembly is joined, and two separators. A hole extends through the holding plate and the separators in a thickness direction. The separators are each bonded to the holding plate using adhesive. Ribs protrude from each of the separators. An uneven surface is provided at a portion of an end face of each of the ribs located between the hole and the membrane electrode gas diffusion layer assembly and a portion of a contact surface of the holding plate located between the hole and the membrane electrode gas diffusion layer assembly. The end face faces in a direction in which the ribs protrude. The contact surface is in contact with the end face.

### CROSS-REFERENCE TO RELATED APPLICATIONS

This application is based upon and claims the benefit of priority from Japanese Patent Application No. 2024-150454, filed on Sep. 2, 2024, the entire contents of which are incorporated herein by reference

### BACKGROUND

### 1. Field

The present disclosure relates to a single cell for a fuel cell.

### 2. Description of Related Art

A cell stack of a fuel cell is formed by stacking single cells in a thickness direction. JP2019-192327A discloses a single cell that includes a holding plate and two separators. The holding plate has the form of a quadrangular frame. The edge of a membrane electrode gas diffusion layer assembly is bonded to the holding plate. The two separators sandwich the holding plate and the membrane electrode gas diffusion layer assembly from the opposite sides in the thickness direction. The separators are each bonded to the holding plate using, for example, adhesive.

The two separators include a separator on the anode side and a separator on the cathode side of the opposite sides of the membrane electrode gas diffusion layer assembly in the thickness direction. A passage through which fuel gas (e.g., hydrogen) flows is provided between the anode-side separator and the anode-side gas diffusion layer. A passage through which oxidant gas (e.g., air) flows is provided between the cathode-side separator and the cathode-side gas diffusion layer. Holes extend through the holding plate and the separators in the thickness direction. Such holes include holes for supplying and discharging fuel gas to and from the passage through which the fuel gas flows and holes for supplying and discharging oxidant gas to and from the passage through which the oxidant gas flows.

Ribs protrude from each of the separators toward the holding plate and the membrane electrode gas diffusion layer assembly. The ribs are parallel to each other. The above-described passages are located between the ribs in the separators. Slits that connect the holes to the passages are provided between the holes of the holding plate and the membrane electrode gas diffusion layer. In the single cell for the fuel cell, fuel gas is supplied to the anode side of the membrane electrode gas diffusion layer assembly through the holes, the slits, and the passages. In the single cell for the fuel cell, oxidant gas is supplied to the cathode side of the membrane electrode gas diffusion layer assembly through the holes, the slits, and the passages. Further, power is generated based on the reaction between the fuel gas and the oxidant gas in the membrane electrode gas diffusion layer assembly.

In the single cell, the separators are each bonded to the holding plate using, for example, adhesive. Thus, a portion of the surface of each separator facing the holding plate and a portion of a contact surface of the holding plate in contact with the surface of the separator, the two portions being located between the holes and the membrane electrode gas diffusion layer assembly, are also bonded to each other using, for example, adhesive.

However, in the bonding between these portions, the presence of the above-described slits reduces the contact area, which may result in a decrease in bonding strength.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect of the present disclosure provides a single cell for a fuel cell. The single cell includes a frame-shaped holding plate to which an edge of a membrane electrode gas diffusion layer assembly is bonded and two separators sandwiching the holding plate and the membrane electrode gas diffusion layer assembly from opposite sides in a thickness direction. A passage through which gas flows is provided between each of the two separators and the membrane electrode gas diffusion layer assembly. A hole extends through the holding plate and the separators in the thickness direction. The hole is provided to supply and discharge gas to and from the passage. The separators are each bonded to the holding plate using adhesive. Ribs protrude from each of the separators toward the holding plate and the membrane electrode gas diffusion layer assembly. The ribs extend in parallel to the hole. The passage is located between adjacent ones of the ribs in each of the separators. An uneven surface is provided at a portion of an end face of each of the ribs located between the hole and the membrane electrode gas diffusion layer assembly and a portion of a contact surface of the holding plate located between the hole and the membrane electrode gas diffusion layer assembly. The end face faces in a direction in which the ribs protrude. The contact surface is in contact with the end face.

Other features and aspects will be apparent from the following detailed description, the drawings, and the claims.

### BRIEF DESCRIPTION OF THE DRAWINGS

FIG. 1 is an exploded perspective view of a single cell for a fuel cell.

FIG. 2 is a cross-sectional view of a cell stack formed by stacking single cells each having the structure shown in FIG. 1.

FIG. 3 is a schematic view showing the ribs and the passages of each separator in the single cell of FIG. 1.

FIG. 4 is a cross-sectional view showing a portion corresponding to each rib in the separator and the holding plate of FIG. 1.

FIG. 5 is a perspective view of the separator shown in FIG. 4 where the ribs converge.

FIG. 6 is a plan view illustrating another example of the positions and extending directions of the projections on each of the ribs in the separator.

FIG. 7 is a plan view illustrating another example of the positions and extending directions of the projections on each of the ribs in the separator.

FIG. 8 is a plan view illustrating another example of the positions and extending directions of the projections on each of the ribs in the separator.

FIG. 9 is a plan view illustrating another example of the positions and extending directions of the projections on each of the ribs in the separator.

FIG. 10 is a plan view illustrating another example of the positions and extending directions of the projections on each of the ribs in the separator.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

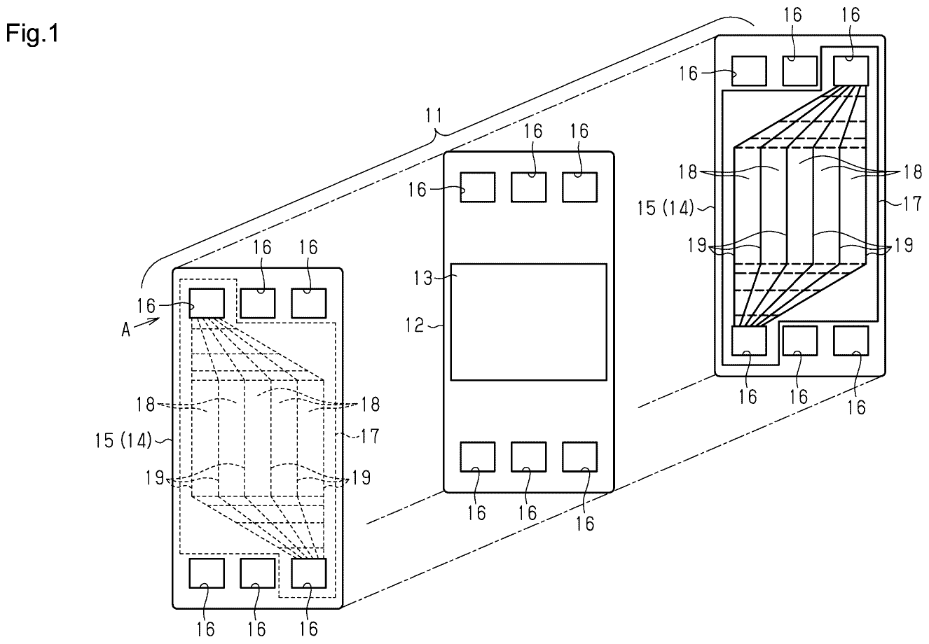

An embodiment of a single cell for a fuel cell will now be described with reference to FIGS. 1 to 5.

FIG. 1 shows a single cell 11 used to form a cell stack of a fuel cell. The single cell 11 includes a holding plate 12, a membrane electrode gas diffusion layer assembly 13, and two separators 14. The holding plate 12 is made of resin, and has the form of a rectangular frame. The edge of the membrane electrode gas diffusion layer assembly 13 is bonded to the holding plate 12. The holding plate 12 and the membrane electrode gas diffusion layer assembly 13 are sandwiched by the separators 14, which are respectively arranged on the opposite sides of the holding plate 12 and the membrane electrode gas diffusion layer assembly 13 in the thickness direction.

The cell stack of the fuel cell is formed by stacking multiple single cells 11 in the thickness direction. Holes 16 extend in the thickness direction through the holding plate 12 and the separators 14 of the single cell 11. Three of the holes 16 are located at one end of the single cell 11 in the long-side direction, and the other three are located at the other end of the single cell 11 in the long-side direction. One of the holes 16 at the one end of the single cell 11 in the long-side direction is paired with one of the holes 16 at the other end. Fluid (e.g., fuel gas such as hydrogen, oxidant gas such as air, and refrigerant such as coolant) flows through each pair of the holes 16.

The separators 14 each include a body 15 that is made of metal (e.g., stainless steel, titanium, or aluminum), and has the form of a rectangular plate. The body 15 includes ribs 19 that are parallel to each other and extend in the long-side direction. A seal member 17 is arranged between the body 15 of each separator 14 and the holding plate 12. The seal members 17 can be disposed on the surfaces of the holding plate 12 on the opposite sides in the thickness direction. The body 15 of the separator 14 is bonded to the holding plate 12 using adhesive, with the seal member 17 arranged between the body 15 and the holding plate 12.

The seal member 17 arranged on the front side of the holding plate 12 surrounds pairs of the holes 16, each pair being positioned along one of the two diagonal lines in the holding plate 12 and the corresponding separator 14. The seal member 17 also surrounds the anode side of the membrane electrode gas diffusion layer assembly 13. The seal member 17 further surrounds the ribs 19 in the anode-side separator 14. Further, a passage 18 through which fuel gas flows is defined between adjacent ones of the ribs 19 in the separator 14. Fuel gas can be supplied to the passages 18 through the pair of holes 16. In other words, the pair of holes 16 allow fuel gas to be supplied to and discharged from the passage 18.

The seal member 17 arranged on the rear side of the holding plate 12 surrounds pairs of the holes 16, each pair being positioned along the other one of the two diagonal lines in the holding plate 12 and the corresponding separator 14. The seal member 17 also surrounds the cathode side of the membrane electrode gas diffusion layer assembly 13. The seal member 17 further surrounds the ribs 19 in the cathode-side separator 14. Further, a passage 18 through which oxidant gas flows is defined between adjacent ones of the ribs 19 in the separator 14. Oxidant gas can be supplied to the passages 18 through the pair of holes 16. In other words, the pair of holes 16 allow oxidant gas to be supplied to and discharged from the passage 18.

In the fuel cell stack of the single cells 11, the fuel gas flows along the anode side of the membrane electrode gas diffusion layer assembly 13, and the oxidant gas flows along the cathode side of the membrane electrode gas diffusion layer assembly 13. When the fuel gas and the oxidant gas respectively flow along the anode side and the cathode side of the membrane electrode gas diffusion layer assembly 13 in this manner, power is generated from the reaction between the fuel gas and the oxidant gas in the membrane electrode gas diffusion layer assembly 13.

### Details of Ribs 19 in Separator 14

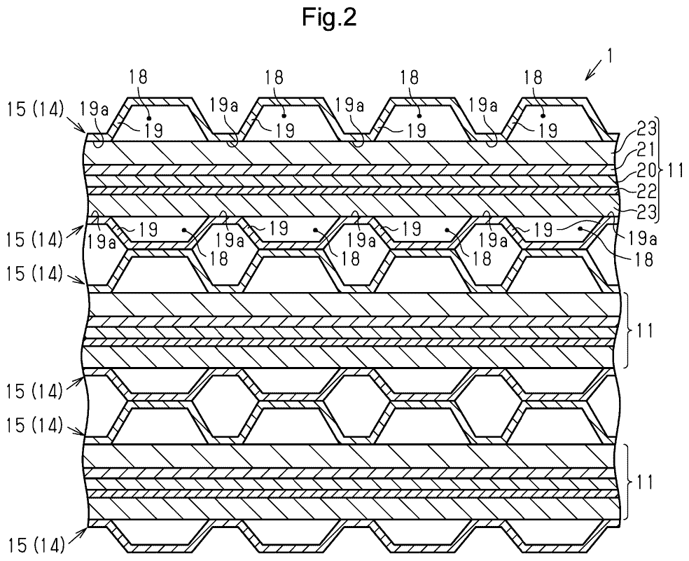

As shown in FIG. 2, the membrane electrode gas diffusion layer assembly 13 of each single cell 11 includes an electrolyte layer 20, a cathode electrode layer 21, an anode electrode layer 22, and a gas diffusion layer 23. The electrolyte layer 20 is formed by, for example, a solid polymer membrane. The cathode electrode layer 21 is bonded to one side of the electrolyte layer 20 in the thickness direction (the upper side in FIG. 1). The anode electrode layer 22 is bonded to the other side of the electrolyte layer 20 in the thickness direction (the lower side in FIG. 1). The surface of the cathode electrode layer 21 opposite the electrolyte layer 20 is covered by the gas diffusion layer 23. The surface of the anode electrode layer 22 opposite the electrolyte layer 20 is covered by another gas diffusion layer 23, which is different from the aforementioned gas diffusion layer 23.

Two separators 14 are respectively located on the cathode and anode sides of the membrane electrode gas diffusion layer assembly 13. Multiple ribs 19 on the cathode-side separator 14 are formed by bending the body 15 so as to protrude toward the cathode-side gas diffusion layer 23. These ribs 19 are in contact with the cathode-side gas diffusion layer 23. End faces 19a of the ribs 19, facing in the direction in which the ribs 19 protrude from the body 15, are parallel to the cathode-side gas diffusion layer 23. The space between the ribs 19 of the separator 14 and between the separator 14 and the gas diffusion layer 23 defines passages 18 through which oxidant gas flows.

Multiple ribs 19 on the anode-side separator 14 are formed by bending the body 15 so as to protrude toward the anode-side gas diffusion layer 23. These ribs 19 are in contact with the anode-side gas diffusion layer 23. The end faces 19a of the ribs 19, facing in the direction in which the ribs 19 protrude from the body 15, are parallel to the anode-side gas diffusion layer 23. The space between the ribs 19 of the separator 14 and between the separator 14 and the gas diffusion layer 23 defines passages 18 through which fuel gas flows.

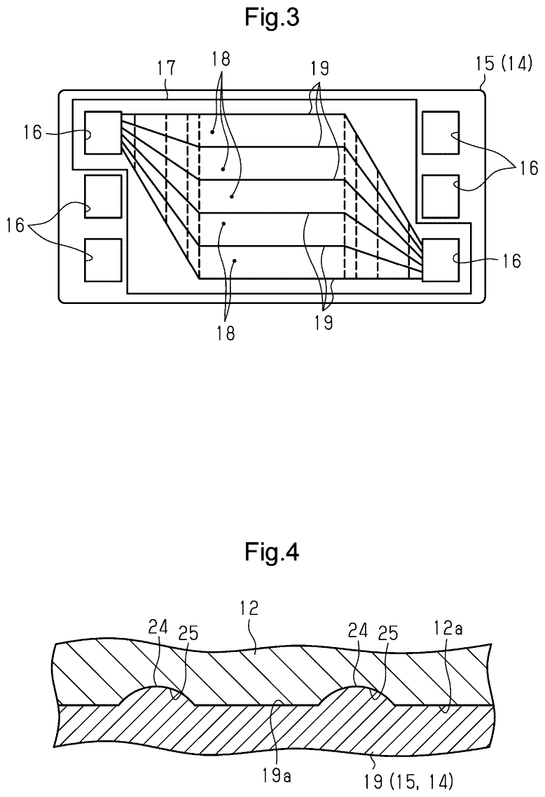

As shown in FIG. 3, the ribs 19, arranged in parallel, converge toward the hole 16 of the body 15 of the separator 14. The ribs 19 reach the hole 16, so that the passage 18 between adjacent ones of the ribs 19 is connected to the hole 16. The portions of the ribs 19 parallel to each other, specifically, the end faces 19a of the portions, are in contact with the gas diffusion layer 23 of the membrane electrode gas diffusion layer assembly 13 as described above. As shown in FIG. 4, the portions of the ribs 19 that converge toward the hole 16, specifically, the end faces 19a of the portions, are in contact with the holding plate 12. The holding plate 12 includes a contact surface 12a that is in contact with the end face 19a.

The end face 19a of each rib 19 is bonded to the contact surface 12a of the holding plate 12 using adhesive. Thus, a portion of the end face 19a of each of the ribs 19 and a portion of the contact surface 12a of the holding plate 12 in contact with the end face 19a of the rib 19, the two portions being located between the hole 16 and the membrane electrode gas diffusion layer assembly 13, are bonded to each other using adhesive. Specifically, the projection 24 is formed through, for example, laser processing, at the portion of the end face 19a of each of the ribs 19 in the protruding direction located between the hole 16 and the membrane electrode gas diffusion layer assembly 13. Further, the recess 25 is formed at the portion of the contact surface 12a of the holding plate 12 in contact with the end face 19a located between the hole 16 and the membrane electrode gas diffusion layer assembly 13, and the projection 24 is accommodated in the recess 25. The projection 24 and the recess 25 define an uneven surface. The above-described portions, including the uneven surface, are bonded to each other.

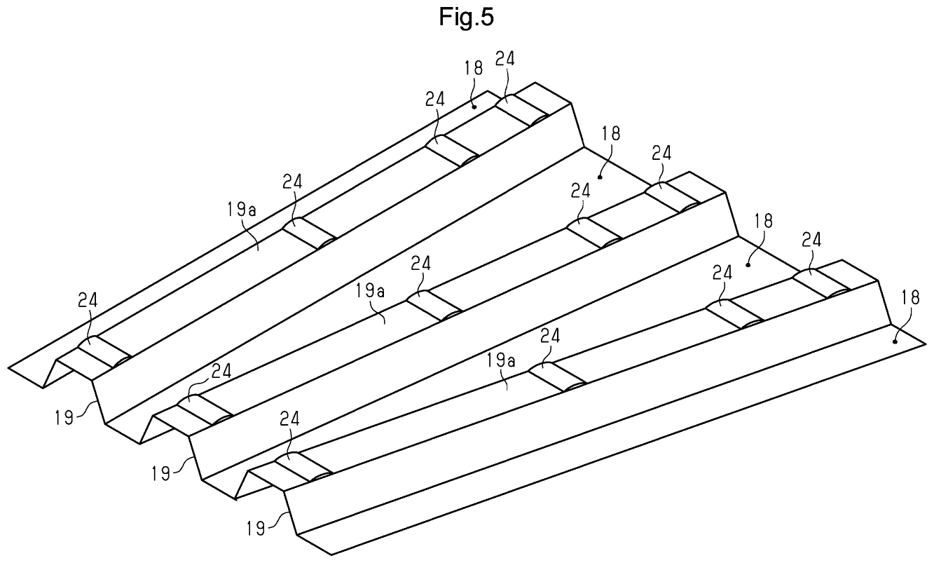

As shown in FIG. 5, the projections 24 extend in a direction intersecting the direction in which the ribs 19 extend. The projections 24 on the end face 19a of each rib 19 and the projections 24 on the end face 19a of another rib 19 adjacent to the rib 19 are located on the same line. One rib 19 includes multiple projections 24 that are provided at predetermined intervals in a direction in which the ribs 19 extend. As indicated by the thick broken lines in FIG. 3, the interval between adjacent ones of the projections 24 become shorter as the distance from the hole 16 increases. Each recess 25, which accommodates the corresponding projection 24, is located at the position corresponding to that projection 24 of each rib 19 of the holding plate 12.

### Operational Advantages of the Single Cell 11 for the Fuel Cell in the Present Embodiment

(1) The portion of the end face 19a of each of the ribs 19 and the portion of the contact surface 12a of the holding plate 12 in contact with the end face 19a of the rib 19, the two portions being located between the hole 16 and the membrane electrode gas diffusion layer assembly 13, are bonded to each other using adhesive. However, in the bonding between these portions, the presence of multiple ribs 19 protruding from the body 15 of each separator 14 tends to reduce the bonding area between the above-described portions to be bonded. As a result, the bonding strength between the above-described portions may decrease. To solve such a problem, the uneven surface is provided at each of the above-described portions to be bonded. The presence of the uneven surface at each of the above-described portions to be bonded increases the contact area at the above-described portions. This obviates a decrease in the bonding strength between the above-described portions resulting from a decrease in the contact area between the above-described portions to be bonded.

(2) Each separator 14 is made of metal, and the holding plate 12 is made of resin.

Thus, the formation of the projection 24 the end face 19a of the rib 19 of the separator 14 through, for example, laser processing, is facilitated. Further, the formation of the recess 25 on the contact surface 12a of the holding plate 12, which is in contact with the end face 19a is facilitated. This facilitates the formation of the uneven surface, which is defined by the projection 24 and the recess 25, at the portion of the end face 19a of the rib 19 and the portion of the contact surface 12a of the holding plate 12 in contact with the end face 19a, the two portions being located between the hole 16 and the membrane electrode gas diffusion layer assembly 13.

(3) If the projection 24 is formed using the mold for the separator 14, the cost of the mold would be relatively high. However, the projection 24 is formed through laser processing, thereby obviating an increase in the cost of the mold. When the projection 24 is formed through laser processing, the projection 24 does not necessarily protrude in an arc shape and is highly likely to have a complicated protruding shape. In this case, the shape of the uneven surface, which is defined by the projection 24 and the recess 25, also becomes complicated. Thus, the bonding at the uneven surface becomes stronger through the anchoring effect.

(4) The projections 24 extend in the direction intersecting the direction in which the ribs 19 extend. The projections 24 on the end face 19a of each rib 19 and the projections 24 on the end face 19a of another rib 19 adjacent to the rib 19 are located on the same line. This facilitates the formation of the projections 24 through laser processing. In other words, when the projections 24 are formed through laser processing, the movement of a laser head used for the laser processing is linear, which facilitates the formation of the projections 24.

(5) The ribs 19, arranged in parallel, extend so as to converge toward the hole 16.

Accordingly, the proportion of the end face 19a of each rib 19 per unit area of the holding plate 12 decreases as the distance from the hole 16 increases. Consequently, as the distance from the hole 16 increases, the bonding strength decreases at the portion of the end face 19a of the rib 19 and the portion of the contact surface 12a of the holding plate 12 that are to be bonded to each other between the hole 16 and the membrane electrode gas diffusion layer assembly 13. However, the interval between adjacent ones of the projections 24 on the rib 19 are made shorter as the distance from the hole 16 increases. The bonding strength at the portions to be bonded to each other is increased by the uneven surfaces, which are defined by the projections 24 and the recesses 25. Thus, the uneven surfaces, which are defined by the projections 24 and the recess 25, limit situations in which the bonding strength at the portions bonded to each other decreases as the distance from the hole 16 increases.

The above-described embodiment may be modified as follows. The above-described embodiment and the following modifications can be combined as long as the combined modifications remain technically consistent with each other.

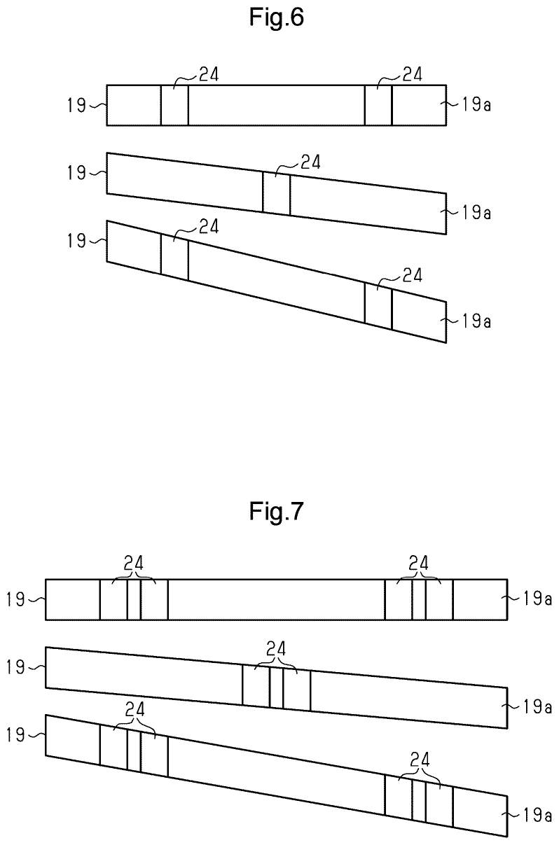

The projections 24 may be arranged on each of the ribs 19 as shown in FIGS. 6 and 7.

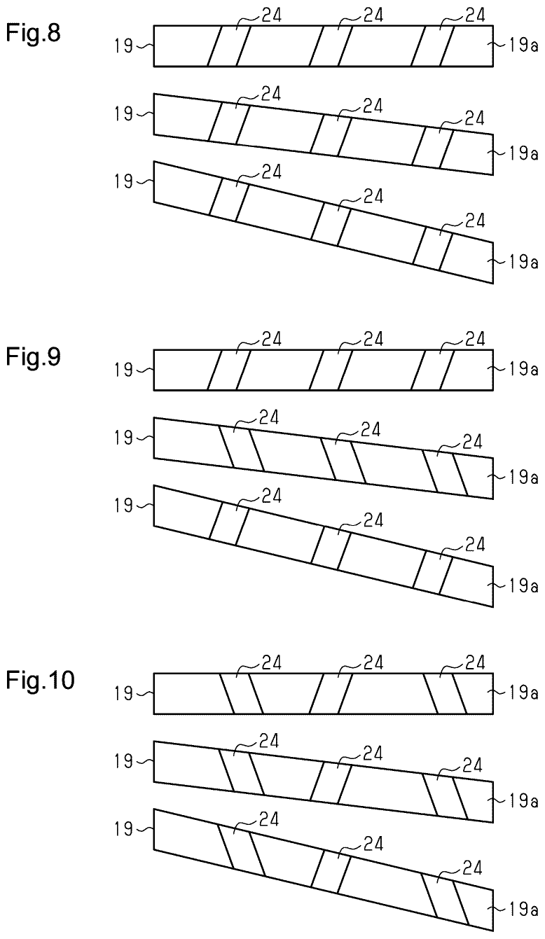

As shown in FIGS. 8 to 10, the projections 24 may extend so as to be inclined with respect to the direction in which the ribs 19 extend.

As shown in FIGS. 9 and 10, each of the projections 24 on each of the ribs 19 extends in a direction that is different from a direction in which other projections 24 extend. In this case, parallel movement of the separators 14 and the holding plate 12 in multiple directions is limited effectively by the projections 24, each extending in a different direction, and the recesses 25, respectively accommodating the projections 24.

The projections 24 do not have to extend in the direction intersecting the direction in which the ribs 19 extend.

The projections 24 do not have to be necessarily formed through laser processing, and may be formed using, for example, a mold for the separator 14.

The material used to form the separators 14 may be changed.

The positional relationship between each projection 24 and the corresponding recess 25 may be reversed.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A single cell for a fuel cell, the single cell comprising:
a frame-shaped holding plate to which an edge of a membrane electrode gas diffusion layer assembly is bonded; and
two separators sandwiching the holding plate and the membrane electrode gas diffusion layer assembly from opposite sides in a thickness direction, wherein
a passage through which gas flows is provided between each of the separators and the membrane electrode gas diffusion layer assembly,
a hole extends through the holding plate and the separators in the thickness direction,
the hole is provided to supply and discharge gas to and from the passage,
the separators are each bonded to the holding plate using adhesive,
ribs protrude from each of the separators toward the holding plate and the membrane electrode gas diffusion layer assembly,
the ribs extend in parallel to the hole,
the passage is located between adjacent ones of the ribs in each of the separators, and
an uneven surface is provided at a portion of an end face of each of the ribs located between the hole and the membrane electrode gas diffusion layer assembly and a portion of a contact surface of the holding plate located between the hole and the membrane electrode gas diffusion layer assembly, the end face facing in a direction in which the ribs protrude, and the contact surface being in contact with the end face.

2. The single cell for the fuel cell according to claim 1, wherein
the separators are made of metal, and the holding plate is made of resin,
a projection is provided at the portion of the end face located between the hole and the membrane electrode gas diffusion laye r assembly, the end face facing in the direction in which the ribs protrude,
a recess is provided at the portion of the contact surface of the holding plate located between the hole and the membrane electrode gas diffusion layer assembly, the contact surface being in contact with the end face, and the projection being accommodated in the recess, and
the uneven surface is defined by the projection and the recess.

3. The single cell for the fuel cell according to claim 2, wherein
the projections are formed through laser processing.

4. The single cell for the fuel cell according to claim 3, wherein
the projections extend in a direction intersecting a direction in which the ribs extend, and
the projections on the end face of each rib of the ribs and the projections on the end face of another rib of the ribs adjacent to the rib are located on the same line.

5. The single cell for the fuel cell according to claim 3, wherein
the projections extend in a direction intersecting a direction in which the ribs extend, and
each of the projections on the ribs extends in a direction that is different from a direction in which other ones of the projections extend.

6. The single cell for the fuel cell according to claim 2, wherein
the ribs, arranged in parallel, extend so as to converge toward the hole,
the projection is one of multiple projections provided at predetermined intervals in a direction in which the ribs extend, and
an interval between adjacent ones of the projections decreases as a distance from the hole increases.
